(19) United States
(12) Patent Application Publication
(10) Pub. No.: US 2010/0223115 A1
(43) Pub. Date: Sep. 2, 2010

(54) ONLINE AND MOBILE GAME APPLICATION WITH A METHOD OF REAL REWARD REDEMPTION

(76) Inventors: David Chodosh, Manhattan Beach, CA (US); Terry Kavanagh, New York, NY (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/716,075

(22) Filed: Mar. 2, 2010

Related U.S. Application Data
(60) Provisional application No. 61/208,899, filed on Mar. 2, 2009.

(51) Int. Cl. G06Q 30/00; G06Q 50/00

(52) U.S. Cl. 705/14.12; 705/14.33

(57) ABSTRACT

An online and mobile game application with a method of real prize redemption is disclosed. According to one embodiment, a computer implemented method comprises establishing a user reward account in response to a registration request, receiving and storing reward accumulation information, and the reward accumulation information is associated with the user reward account. Reward accumulation information is displayed, along with reward reports, and reward reports are displayed according to selection criteria. A reward certificate is displayed in response to a request to redeem a reward, and user reward account information is synchronized with a web application.

The present application claims the benefit of and priority to U.S. Provisional Patent Application No. 61/208,899 entitled “ONLINE AND/OR MOBILE GAME APPLICATION WITH METHOD OF REAL PRIZE REDEMPTION” filed on Mar. 2, 2009, and is hereby incorporated by reference.

### FIELD

The field of the invention relates generally to computer systems. In particular, the present invention is directed an online and mobile game application with a method of real reward redemption.

### BACKGROUND

In nearly every online and mobile game, players compete against each other or the game itself, and the goal is usually to score more points than the opponent or opponents, or to acquire or accumulate. By doing so, that player has the satisfaction of calling himself the winner, and possibly claiming a place in the all-time total points list. However, by competing for a real reward of actual value instead of points or a “virtual” reward, the game play becomes more compelling and competitive. The winner has the added benefit of receiving a relevant, useable gift for his victory. The reward sponsor can have a new way to promote a product. The game publisher/developer can receive a share of revenue from the sponsor. Advancements and the ubiquity of mobile devices have created new opportunities for retailers and manufacturers (sponsors) to connect with consumers more directly and frequently. This allows for more rich and relevant content to be transferred through media i.e. games, video, ebooks, music.

### SUMMARY

An online and mobile game application with a method of real prize redemption is disclosed. According to one embodiment, a computer implemented method comprises establishing a user reward account in response to a registration request, receiving and storing reward accumulation information, and the reward accumulation information is associated with the user reward account. Reward accumulation information is displayed, along with reward reports, and reward reports are displayed according to selection criteria. A reward certificate is displayed in response to a request to redeem a reward, and user reward account information is synchronized with a web application.

The above and other preferred features, including various novel details of implementation and combination of elements, will now be more particularly described with reference to the accompanying drawings and pointed out in the claims. It will be understood that the particular methods and circuits described herein are shown by way of illustration only and not as limitations. As will be understood by those skilled in the art, the principles and features described herein may be employed in various and numerous embodiments without departing from the scope of the invention.

### BRIEF DESCRIPTION

The accompanying drawings, which are included as part of the present specification, illustrate the presently preferred embodiment and together with the general description given above and the detailed description of the preferred embodiment given below serve to explain and teach the principles of the present invention.

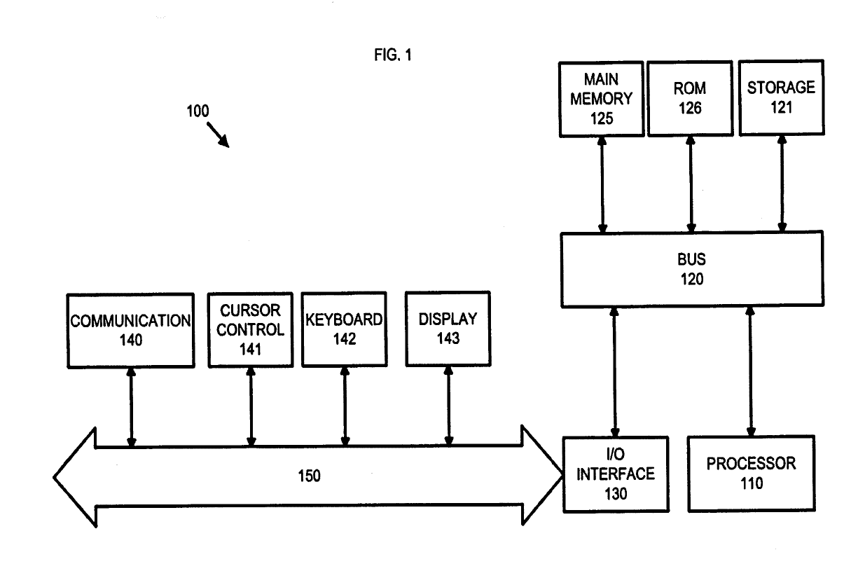

FIG. 1 illustrates an exemplary computer architecture for use with the present system, according to one embodiment.

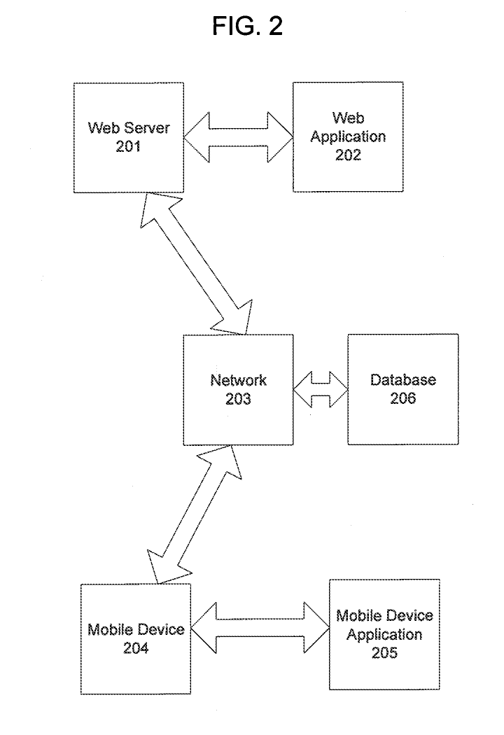

FIG. 2 illustrates a system level layout for use with an online and mobile game application with a method of real reward redemption, according to one embodiment.

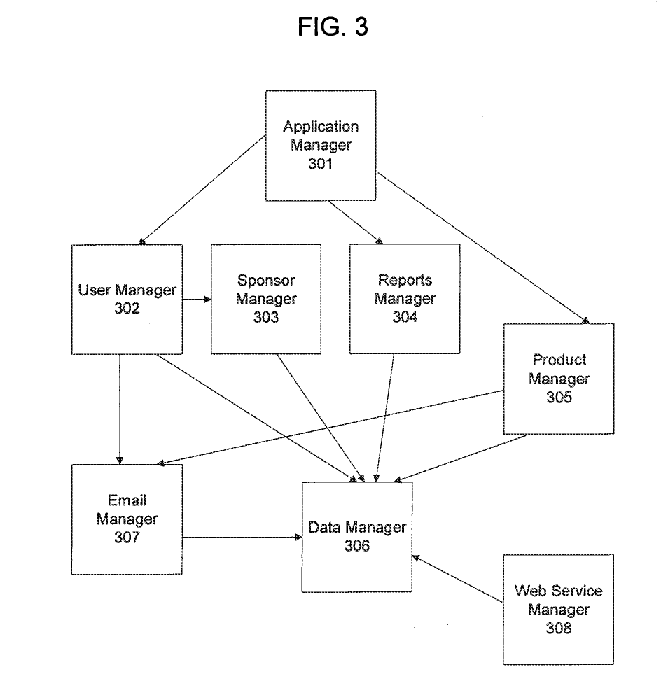

FIG. 3 illustrates a component level diagram of a web application for use with an online and mobile game application with a method of real reward redemption, according to one embodiment.

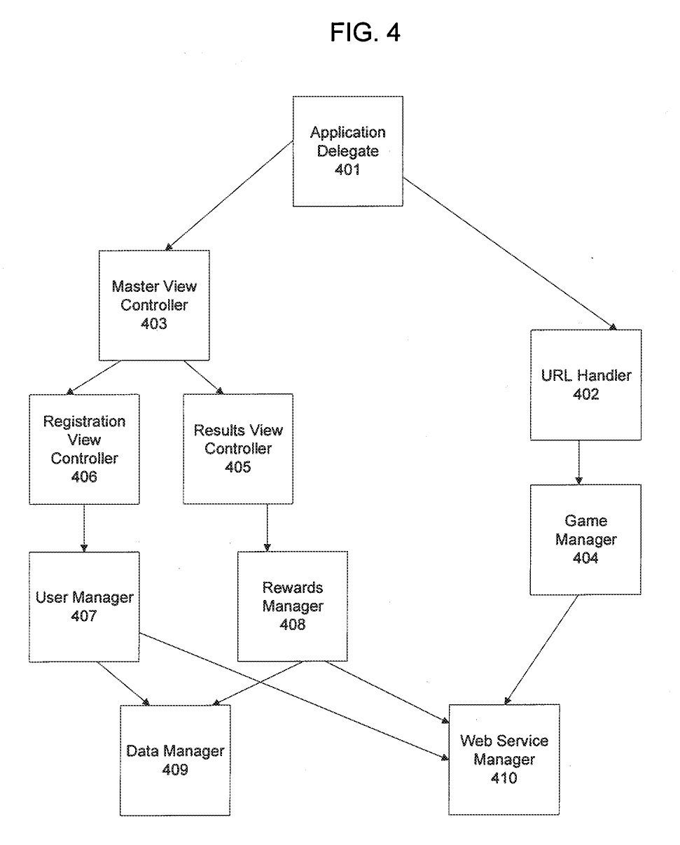

FIG. 4 illustrates a component level diagram of a mobile device application for use with an online and mobile game application with a method of real reward redemption, according to one embodiment.

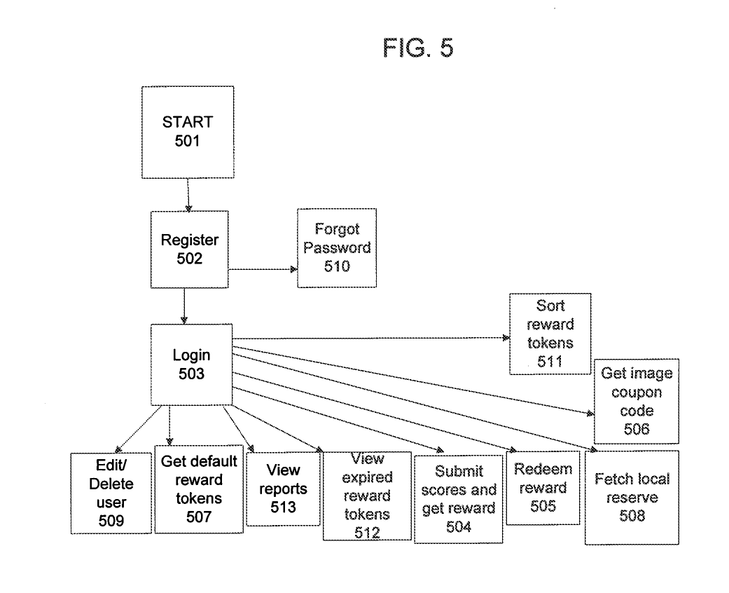

FIG. 5 illustrates a game user action process within an online and mobile game application with a method of real reward redemption, according to one embodiment.

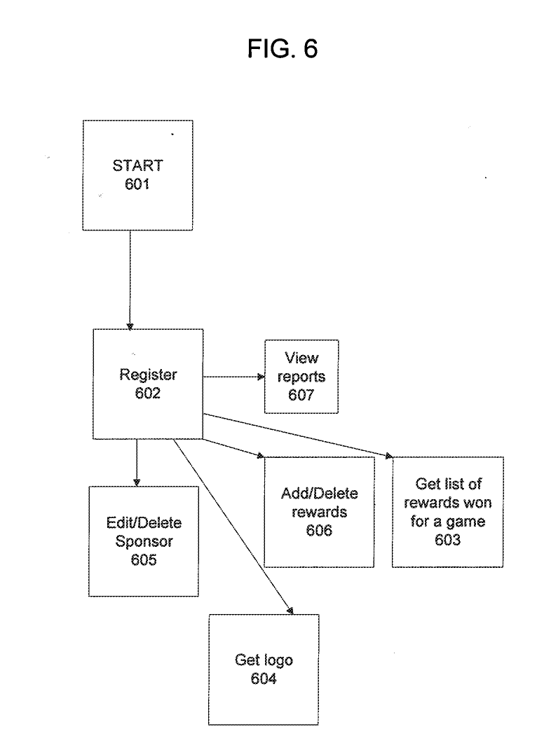

FIG. 6 illustrates a sponsor action process within an online and mobile game application with a method of real reward redemption, according to one embodiment.

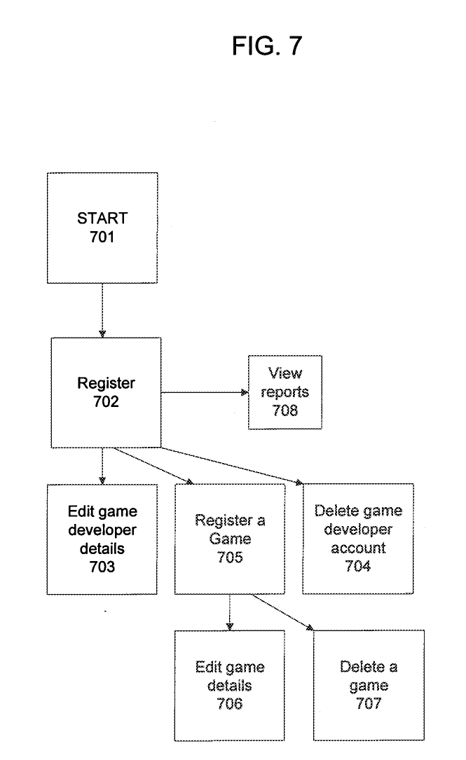

FIG. 7 illustrates a game developer action process within an online and mobile game application with a method of real reward redemption, according to one embodiment.

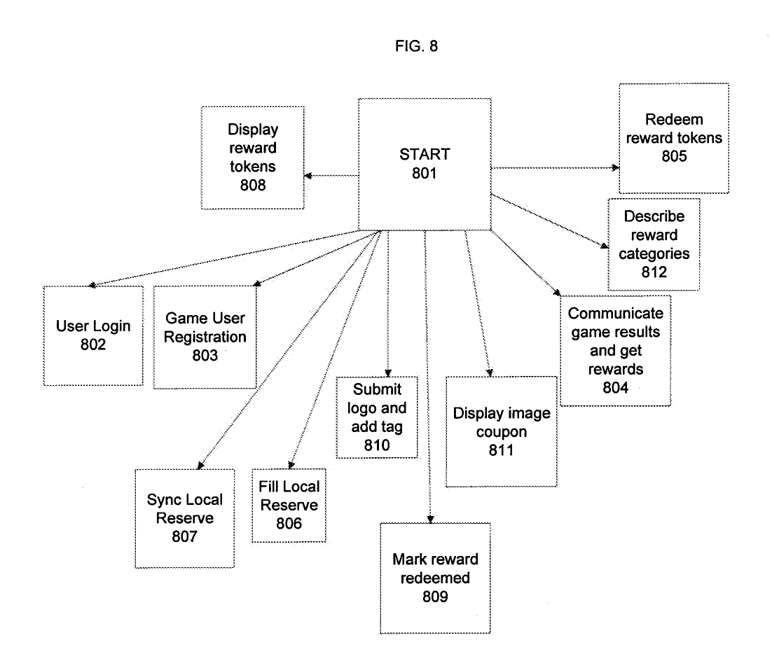

FIG. 8 illustrates a mobile application device process within an online and mobile game application with a method of real reward redemption, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

An online and mobile game application with a method of real prize redemption is disclosed. According to one embodiment, a computer implemented method comprises establishing a user reward account in response to a registration request, receiving and storing reward accumulation information, and the reward accumulation information is associated with the user reward account. Reward accumulation information is displayed, along with reward reports, and reward reports are displayed according to selection criteria. A reward certificate is displayed in response to a request to redeem a reward, and user reward account information is synchronized with a web application.

The present system includes an application that registers game results and facilitates sponsoring reward tokens (referred to herein as “rewards”) for game users based on game results. Examples of mobile devices for use within the present system include but are not limited to iPhones, smartphones, and any mobile device capable of receiving a text message or connecting to the internet. The application includes a mobile device application in communication with a web server based application. The application enables game developers, game users, and sponsors to register themselves online, or via administrator. Game developers edit their details and register their game details online or via administrator. Sponsors or administrators edit sponsor details and choose categories associated with their offers for providing rewards. Game users register with the application website and view their reward details. Users can view online reports like top games and top active users. Sponsors and game developers can view reports on specific campaigns and games in which they play a role. Mobile device games can communicate with the mobile device application to communicate game results. The mobile device application also enables game users and sponsor to view the game results and mark the rewards redeemed.

The present system enables players to win a real reward in a mobile or online game. The reward may be determined, randomly generated, or selected by the winner from one or more choices. The choices may be displayed graphically on the device's monitor, or announced audibly from an audible voice programmed into the game, or transmitted invisibly to the user's account without a visible or an audible announcement.

According to one embodiment, the reward winner is notified that he has won a reward and a reward certificate is displayed to the winner. The reward certificate may include the name, description, photo or illustration, and manufacturer of the reward, and any instructions needed to redeem the reward (e.g. a store name and location, or a website address). The reward certificate also includes a unique barcode, and/or promotiontion code from the reward's manufacturer or store that identifies the reward and the game and publisher from which the reward was won.

Once it is won, the reward certificate is transferred from the game's program to a storage file or directory on the player's mobile device, and on a website that can be accessed by the player via the internet. If the reward is won by a player who is playing on someone else's device, the winner can transfer or send the reward certificate to his own reward file. The reward file organizes the rewards and has an identifying system so the player can easily see what rewards are in the rewards file. When it is time to redeem the reward, the winner may request that the reward code be sent to a website, or to the user's mobile phone, email or printer. While at a brick and mortar store, the reward is redeemed when the user presents the unique ID promotion code or barcode by showing the certificate to the store clerk. The unique ID code may also be entered into the register or keypad on swiper terminal. The clerk can otherwise scan the barcode from the certificate which is either on the winner's mobile device or on a paper. The clerk can also enter the associated data into the store's computer or cash register, thereby automatically identifying the reward. The clerk then gives the actual reward to the winner. If the reward winner prefers going to the online redemption website, he enters the reward identification number from the certificate and is rewarded the reward either by a receiving a discount or an actual product that is shipped to them, a download (i.e. a music reward), or via an emailed coupon that can be printed by the winner for future use at a store. To ensure that the reward is rewarded a pre-determined number or times or indefinitely, the player is asked to confirm that he wants to redeem the reward, and the reward certificate is erased from the reward file.

The redemption website's program may retain a record of the reward, the game and publisher, the winner's mobile phone number, email, and the origin (i.e. the device's unique ICCID (Integrated Circuit Card ID) number). The record can be retrieved later by the sponsor.

The present system for real rewards is a benefit to the sponsor, the game publisher, and the reward winner. It is a valuable advertising tool for the sponsor that can promotionte a product to the player, and can entice a customer into a store or website. By including a chance to win real rewards, the game is made more appealing and memorable, and the game publisher can promote the game as having extra value and receive income from a sponsor. The notion of winning a real reward provides the player a chance to have an actual gift, product, or discount instead of just extra points.

The present system includes a software application, that can be embedded into any mobile or online game program by a game publisher. This application also includes a method of transferring the reward certificate into a reward file, which the player can access directly. It is up to the player to use or discard any of the rewards that are won.

According to one embodiment of the present system, users sign up and request preferred product reward categories, e.g. apparel, cosmetics, sporting goods. The available rewards, provided by sponsors, are sorted and distributed to users who requested those reward types. The rewards are also prioritized based on nearness to expiration, and other variables. The present system also enables targeted geographic and demographic matching for rewards.

According to one embodiment of the present system, a user chooses to redeem a reward and a redemption window is displayed on the mobile device having a mobile device application. The redemption window has a logo, a barcode, a promotion code, a working countdown clock to indicate a valid reward token (as opposed to a screen shot, for example), and the actual date and time the user requested the coupon. These features of the redemption window enable dynamic verification of reward tokens.

The present system includes a process by which a user indicates an intent to redeem an reward. The process of indicating intent to redeem includes the user requesting a reward token and receiving it on his mobile device. The user replies to confirm, indicating an intent to redeem, and then receives a unique promotion code. The unique promotion code can expire at a certain time defined by the sponsor.

According to one embodiment, a user has a single account that is accessible via an online webpage and via the user's mobile device application. The mobile device application synchronizes with the webpage to ensure matching data.

According to one embodiment, the web application and mobile device application mirror one another in functionality with the exception of how a user registers using each of them. Additionally, while use cases described herein involve a game user, a sponsor, and a game developer with varying levels of capabilities, an administrator of the present system can perform all capabilities available in the system.

According to one embodiment, a sponsor pays the provider of the online and mobile game application when a user acquires a reward token and when a user redeems a reward token. The present system enables a sponsor to have an advertising budget that includes a pre-purchased number of reward tokens for acquisition, and the balance is held for future redemptions. The sponsor's account is periodically (e.g. once a month) analyzed, and reserve money not yet spent on redemption can be redirected and used for more reward token acquisition.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present method and system also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the method and system as described herein.

FIG. 1 illustrates an exemplary computer architecture for use with the present system, according to one embodiment. One embodiment of architecture 100 comprises a system bus 120 for communicating information, and a processor 110 coupled to bus 120 for processing information. Architecture 100 further comprises a random access memory (RAM) or other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

A data storage device 127 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141).

The communication device 140 allows for access to other computers (servers or clients) via a network. The communication device 140 may comprise one or more modems, network interface cards, wireless network interfaces or other well known interface devices, such as those used for coupling to Ethernet, token ring, or other types of networks.

FIG. 2 illustrates a system level layout for use with an online and mobile game application with a method of real reward redemption, according to one embodiment. A web server 201 hosting and thereby in communication with a web application 202 is in communication with a network 203. Also in communication with the network 203 is a mobile device 204. The mobile device 204 has installed thereon a mobile device application 205. A database 206 is in communication with the network 203, and therefore is accessible by both the mobile device 204 and the web server 201. A secure connection is enabled when the mobile device application 205 communicates with the web application 202. The server 201 and database 206 include architectures similar to what is described in FIG. 1, according to one embodiment.

According to one embodiment, the mobile device 204 sends a token ID and hardware ID of the mobile device 204 to a push notification system (PNS) upon installation of the mobile device application 205 on the mobile device 204. The token ID and hardware ID are stored in the database. The web application 202 runs a check daily on the local reserve reward tokens that are sent to the mobile device 204. If the reward tokens are expired then a notification is sent to the PNS. The PNS pushes a notification to the appropriate mobile device 204 when the mobile device 204 is online or as soon as the mobile device 204 comes online. The web server 201 sends a notification automatically to the mobile device 204 every day.

FIG. 3 illustrates a component level diagram of a web application for use with an online and mobile game application with a method of real prize redemption, according to one embodiment. An application manager 301 is responsible for handling all main user interface related events, and communicates to a reports manager 304, a user manager 302, and a products manager 305. The user manager 302 handles all of the game user related operations. Examples include user creation, administrator operations, game user registration, and canceling registration. The user manager communicates with a sponsor manager 303, an email manager 307, and a data manager 306.

The sponsor manager 303 handles all of the game sponsor related operations, example include sponsor registration and canceling sponsor registration. The sponsor manager 303 communicates to the data manager 306. The reports manager 304 handles all related backend operations for producing various reports on the web application. The reports manager 304 communicates to the data manager 306. The email manager 307 manages all outgoing emails, for both forgotten user passwords and reward tokens being sent over email. The email manager 307 uses the data manager 306 to obtain the email IDs and reward bean information. The data manager 306 handles all database related operations for the web application. A web service manager 308 handles communicating with the application parsing the correct input values and generating appropriate response parameters.

FIG. 4 illustrates a component level diagram of a mobile device application for use with an online and mobile game application with a method of real prize redemption, according to one embodiment. An application delegate 401 handles all of the events related to launching and stopping of the application, and communicates with a master view controller 403 and a URL handler 402. The master view controller 403 serves as the front handler for receiving and redirecting all user interface events, and communicates to a registration view controller 406 and a results view controller 405. The URL handler 402 registers the mobile device application that is invoked on a special web service interface from mobile device games, and communicates with a game manager 404.

The registration view controller 406 manages the user registration operation from the mobile device, and communicates with a user manager 407. The results view controller 405 manages the user interface for game rewards results from the mobile device, and communicates with a rewards manager 408. The user manager 407 handles all user related backend operations. Examples include input validations, storing user data using the data manager 409, and communicating with the web application's web services.

The rewards manager 408 handles all reward related backend operations. Examples include input validations, storing rewards data using the data manager 409, and communicating with the web application's web services. The rewards manager 408 and user manager 407 also communicate with a web service manager 410. The data manager 409 handles all database related operations for the mobile device application. The game manager 404 handles backend related operations for external interactions with interfacing game applications, and communicates with the web service manger 410. The web service manager 410 communicates with the web application through invocation of service APIs, passing the correct input arguments, and parsing and understanding the response parameters.

FIG. 5 illustrates a game user action process within an online and mobile game application with a method of real reward redemption, according to one embodiment. A game user action process starts 501 when a user registers 502 using a web service. A message indicating success or failure of registration is displayed to the user. The game user subsequently logs in 503 and can edit details associate with the game user account or delete the game user account 509. Game user private details are encoded and stored in a database. The game user gets a default allocation of reward tokens 507, and can view reports 513. The game user can also view expired reward tokens 512 and sort reward tokens 511. The game user can submit scores and get a reward 504 and redeem rewards 505. The game user can fetch a local reserve of reward tokens 508, and get an image coupon code 506. The user can get assistance with a forgotten password 510. According to one embodiment, parameters involved in game user registration or creation include the following.

Request Parameters:
Action: gameuserregister
Request->uid: request a user ID from the user
Request->pwd: request a password from the user
Request->phone: request a mobile phone number from the user
Request->email: request an email from the user
Request->zipcode: request a zipcode from the user
Request->deviceid: request the mobile device hardware id.
Request->Security question and answer
Request->City, state, country, zip code

Response Parameters:
Status: ‘0’ indicates a successful registration, ‘1’ indicates a failure.
Response->errcode: ‘Empty’ indicates a success, ‘1’ indicates a database failure, and ‘2’ indicates a duplicate user.

To edit or delete a user account, the game user 501 logs in with proper credentials and provides a registered game user ID for editing or deletion. An administrative user approves the editing of user details or the deletion of the user, and the details are updated or marked for deletion as appropriate. A message indicating success or failure of the editing or deletion is displayed to the user.

According to one embodiment, parameters involved in user login include the following.

Request Parameters:
Action: login
Request->uid: request a user ID from the user
Request->pwd: request a password from the user
Request->deviceid: request the mobile device hardware id.

Response Parameters:
Response->uid: the type of user logged in
Response->rewards: an array of rewards won for games. Each object in the array contains a game ID and reward type won by the user.

According to one embodiment, parameters involved in submitting scores include the following.

Request Parameters:
Action: getreward
Request->uid: request a user ID from the user
Request->gameid: request a game ID from the user
Request->level: request the level of the game (optional).
Request->scores: request the score of the game. Scores are represented as 16-bit integers.
Request->duration: request the duration of the game played for this level in seconds (optional).

Response Parameters:
Response->rewards: an array of reward objects. Each object in the array contains an reward ID and reward type won.

According to one embodiment, parameters involved in redeeming an reward include the following.

Request Parameters:
Action: redeemreward
Request->rewardid: request an reward ID from the user
Request->gameuserid: request a game user ID from the user
Request->scoreid: request the scoreid from the user.
Request->uid: request a user ID from the user
Request->pwd: request a password from the user
Request->hardwareid: request a mobile device hardware id.

Response Parameters:
Response->textcoupon: a string of a text coupon.

According to one embodiment, parameters involved in getting an image coupon code include the following.

Request Parameters:
Action: imageCoupon
Request->scoreid: request the scoreid from the user.
Request->uid: request a user ID from the user
Request->pwd: request a password from the user
Request->hardwareid: request a mobile device hardware id.

Response Parameters:
Response->image: binary data. The images of stream data are sent in binary data format.

According to one embodiment, parameters involved in getting an allocation of default reward tokens include the following.

Request Parameters:
Action: allocateAndGetDefaultRewardtokens
Request->uid: request a user ID from the user
Request->pwd: request a password from the user

Response Parameters:
Response->rewards: an array of reward objects, with each reward object having reward details.

According to one embodiment, parameters involved in fetching local reward tokens include the following.

Request Parameters:
Action: fetchLocalReserve
Request->uid: request a user ID from the user
Request->pwd: request a password from the user
Request->hardwareid: request mobile device hardware D.

Response Parameters:
Response->reward tokens: an array of reward token objects with bean details.
Response->beangamemap: an array of beangamemap objects with bean and game details.

According to one embodiment, parameters involved in updating local reward tokens include the following.

Request Parameters:
Action: updateLocReserveRewardtokens
Request->updatedlocalreserveRewardtokens: request an array of local reserve reward token details
Request->hardwareid: request mobile device hardware ID.

Response Parameters:
Status: ‘0’ indicates a success, ‘1’ indicates a failure.
Response->errcode: ‘Empty’ indicates a success, ‘1’ indicates a database failure, and ‘2’ indicates a duplicate user.

If the game user forgets a password, the game user provides a user ID, security question and answer, and an email. A temporary password is emailed to the user and upon subsequent login the user is prompted to change the password.

Options for sorting reward tokens include the soonest to expire, name of sponsor, nearest locations and type of reward token. According to the user sorting selection, the reward tokens are sorted and displayed. Expired reward tokens are displayed to the user in a report page containing all available reward tokens won by the user.

According to one embodiment, game achievements trigger reward token allocation. Reward token allocation is automatic and is transparent to the game user. For example, a game user reward account is updated with reward tokens immediately upon the game user achieving a particular score, level of a game, or other achievement. In other words, reward token allocation does not require input from the game user.

FIG. 6 illustrates a sponsor action process within an online and mobile game application with a method of real reward redemption, according to one embodiment. A sponsor process starts 601 with a sponsor registering a sponsor account 602. A sponsor can edit or delete a sponsor account 605, and view reports 607. The sponsor can add or delete sponsored awards 606, and get a list of rewards won for a particular game 603. The sponsor can also get a logo 604.

Details provided by a sponsor upon registration include a sponsor ID, a sponsor name, a password, city, state, country, zip code, company name, office address, office phone number, email, security question and answer, mobile advertising methods (e.g. SMS, voice campaign, mobile application advertisements), description about advertising methods, and an agreement to terms. The sponsor private details are encoded and stored in a database. The sponsor ID must not already be registered in the system, and an administrative user approves the registration. A message indicating registration success or failure is displayed to the sponsor.

Sponsor details that can be edited include a sponsor name, password, city, state, country, zip code, company name, office address, office phone number, email, security question and answer, mobile advertising methods, and description of mobile advertising methods. The sponsor ID must be registered in the system for both editing and deleting operations. Sponsor details are updated upon approval by an administrative user, and the sponsor is notified of the success or failure of editing. Sponsor details are marked as removed upon receipt of the sponsor ID to be deleted and approval by the administrative user.

In case of deletion failure, an appropriate error message is displayed to the game sponsor.

To add or delete rewards, the sponsor logs in and selects one or more product categories in which to sponsor rewards. The sponsor provides details to add a reward, the details include a description of a product offer, a unique reward ID or name, a text coupon code, an image coupon, an indication of SMS or email notification, an expiration period for reward tokens, life period of a reward token (e.g. single use, multiple use, unlimited use) a unique coupon ID, a rating based upon target audience, and a location of service. The text coupon code and the image coupon bar code are compulsory while adding the reward information.

A unique reward weight is calculated by the number of rewards per day per game. For example, if sponsor A is giving 1000 coupons to be given out in 10 days and sponsor B is giving 2000 coupons to be given out in 10 days, for every coupon of sponsor A given out during distribution, 2 of sponsor B are given out. The reward ID must not be registered in the database already, and the game sponsor is logged in from his or her ID. A success or error message is displayed to the game sponsor to indicate the outcome of adding a reward. When a sponsor wants to delete a reward, the sponsor enters the sponsor ID and reward ID. If the sponsor ID and reward ID are registered in the system, the details are marked for deletion upon approval by the administrative user. An outcome message is displayed to the sponsor.

According to one embodiment, parameters involved in getting a list of rewards won for a campaign include the following.

Request Parameters:
Action: getrewardlist
Request->uid: request a user ID of the user
Request->pwd: request a password of the user
Request->gameid: request the game id of the user.

Response Parameters:
Response->rewardlist: an array of reward objects. Each object in the array contains a game user ID and reward type won.

According to one embodiment, parameters involved in submitting a logo include the following.

Request Parameters:
Action: sponsorlogo
Request->scoreid: request a scoreid
Request->uid: request a user ID of the user
Request->pwd: request a password of the user

Response Parameters:
Response->image: binary data. The images of stream data are sent in binary data format.

FIG. 7 illustrates a game developer action process within an online and mobile game application with a method of real reward redemption, according to one embodiment. A game developer action process starts 701 with a game developer registering a game developer account 702. The game developer can then edit game developer details 703 and delete a game developer account 704. The game developer registers a game 705, edits game details 706, and deletes games 707. The game developer also views reports 708.

Examples of details given by a web user to create or register a game developer include but are not limited to User ID, password, city, state, country, zip code, company name, office address, office phone number, email, a security question and answer, agreement to terms, and selection of SMS or email notification. A unique ID for the game developer is stored in a database, and private details of the game developer are encoded and stored in the database. A game developer user ID which is to be created should not be available in the database to prevent duplicate user IDs. If the user ID is not unique across the system, the user is prompted to enter an alternate ID. If the user ID creation fails, an error message is displayed and the game developer is notified to retry later. An administrative user approves the registration of the game developer.

Examples of game developer details that can be edited online (upon providing a valid game developer ID) include password, city, state, country, zip code, company name, office address, office phone number, email, security question and answer, and mechanisms for SMS or email notification. In order for the game developer details to be edited, the game developer's user ID must be available in the database, and the game developer is logged in with his or her ID. The updated game developer details are persisted, and the administrative user approves the edited details.

A game developer account is deleted using the game developer's ID, and a confirmation is requested before the ID is marked as removed in the system. The game developer user ID must be available in the database for deletion, and the administrative user approves the deletion. The game details submitted by the developer are still persisted after the deletion of the account.

Details provided by a game developer upon registering a new game include a game ID, a game name, game levels, a game description, game screenshots, a category, and a rating based on the target audience. A unique game ID is generated in the system for managing the game. The game ID must not have been registered already in the system, and the administrative user approves the game. If there is a failure in adding the game to the system, an appropriate error message is displayed to the game developer.

Details available for editing include a game name, game levels, game description, game screenshots, category, and rating. The game ID is provided as input for changing the details. The game ID must be registered in the system, and changes are approved for an administrative user. The outcome (success or failure) of the editing operation are displayed to the game developer.

To delete a game, the game developer provides the game ID to be marked ‘removed’ in the database, and the game ID must already be registered. An administrative user approves the deletion of the game, the game's other details are persisted in the database, and any failure of removal results in a notification to the game developer.

It is noted that all actions taken by a game user, sponsor, and developer in FIGS. 5, 6, and 7, can be performed by an administrative user.

According to one embodiment, a web user, which can be a game user, a sponsor, a game developer, or an administrative user can perform additional functions. A web user generates reports. Exemplary report types and descriptions include the following, according to one embodiment.
Per game report: Generated by game developers, sponsors, and users. View reports and statistics about games that have been published, sponsored, and played. Reports can be based on geographic location.
Popular game report: Generated by game developers, sponsors, and users. Reports on what popular games are being played based on the maximum user hits and sponsor registration.
Top active game user report: Generated by game developers and sponsors to view the top game players for each game being published or sponsored.
Per user report: Generated by game developers, sponsors, and users for viewing individual statistics.
Hall of fame: Top reward sponsors, winners, and redeemers.
reward token list: A game player can view all his won valid reward tokens, a sponsor can view sponsored reward tokens. Reports can be based on geographic location.

According to one embodiment, a web user blogs to communicate with others. The web user can create a new blog entry, add comments about a blog entry, preview blog entries and comments, access a rich text editor to add well formatted blog entries, and list blog entries based on date or user.

According to one embodiment, a web user accesses a forum to communicate with others. The web user can create a new forum thread entry, access a rich text editor to add well formatted forum entries, add comments about forum threads, and list forum entries based on date or user. An administrator approves or deletes forum entries and threads.

According to one embodiment, a web user communicates with other social network users. The web user can create online book marks, tags, and share links. The web user can also view a report of which games have reward tokens.

FIG. 8 illustrates a mobile device application process within an online and mobile game application with a method of real reward redemption, according to one embodiment. A mobile device application process starts 801 and a user logs into a mobile device application 802. The mobile device application requests a new game user registration 803. The user supplies a user ID and password to the application. The application sends a communication to the web application for authentication and validation. A new game user is created and default reward tokens are allocated.

The mobile device application communicates game results with a web application and receives rewards 804. The mobile device application communicates with a web application when a game player wishes to redeem reward tokens 805. When a game player logs into the mobile device application for the first time, the application communicates to the web application and receives a fill of local reward tokens 806. The local reserve of reward tokens on the mobile device 807 are synchronized when a game player logs into the mobile device application. The mobile device application displays reward tokens 808 to the user. The mobile device application marks rewards redeemed 809. The mobile device application provides for the opportunity to submit a logo and add a tag 810 and displays an image coupon 811.

The mobile device application also provides the opportunity to describe reward categories 812. The functions listed above with respect to elements in FIG. 8 are described throughout the document, specifically in FIGS. 2 through 7. Functions listed as available through the mobile device application 801 are also available through the web application, according to one embodiment.

According to one embodiment of the present system, a store redemption process enables a customer to input a promotion code directly into a POS (point of sale) module without requiring any magnetic card. The user types the promotion code number into the keypad that is used for credit/debit cards.

According to one embodiment of the present system, a store generates a paper coupon as a reward and it is retained in their cash register for their own redemption. Stores that receive paper coupons send the coupons to a clearing house for payment, and this is an alternate way for them to do so while still allowing the user to receive their reward by either showing the reward certificate to the clerk, or by inputting the promotion code into the POS module.

An online and mobile game application with a method of real reward redemption has been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

We claim:

1. A computer-implemented method, comprising:
establishing a user reward account in response to a registration request;
receiving and storing reward accumulation information, wherein the reward accumulation information is associated with the user reward account;
displaying the reward accumulation information;
displaying reward reports, wherein reward reports are displayed according to selection criteria;
displaying a reward certificate in response to a request to redeem a reward; and
synchronizing user reward account information with a web application.

2. The computer-implemented method of claim 1, wherein the user reward account is accessible via the web application and a mobile device.

3. The computer-implemented method of claim 1, further comprising:
receiving and storing registration information for a game and edits to the game details.

4. The computer-implemented method of claim 1, further comprising:
receiving and storing registration information for a sponsor and edits to the sponsor details.

5. The computer-implemented method of claim 1, further comprising:
receiving and storing registration information for a developer and edits to the developer details.

6. The computer-implemented method of claim 1, further comprising:
receiving and storing registration information for a user and edits to the user details.

7. The computer-implemented method of claim 1, wherein the reward certificate includes at least one of a bar code, a time stamp, a promotion code, a store location, sponsor URL, and a sponsor logo.

8. The computer-implemented method of claim 1, further comprising receiving a category designation associated with a user reward account and distributing rewards to the user reward account according to the category designation.

9. The computer-implemented method of claim 8, wherein the category designation is at least one of apparel, cosmetics, sporting goods, geographic location, gender, and age group.

10. The computer-implemented method of claim 1, wherein the selection criteria is at least one of individual user statistics, top reward sponsors, top reward winners, top reward redeemers, sponsored rewards, geographic location, top game players, game popularity, and historical reward information.

11. A system, comprising:
a server hosting a website, the server in communication with a network, the website having a web application;
a database in communication with the network; and
a mobile device in communication with the network, the mobile device having a software application installed thereon, wherein the software application when executed causes the mobile device to:
establish a user reward account in response to a registration request;
receive and store reward accumulation information, wherein the reward accumulation information is associated with the user reward account;
display the reward accumulation information;
display reward reports, wherein reward reports are displayed according to selection criteria;
display a reward certificate in response to a request to redeem a reward; and
synchronize user reward account information with the web application.

12. The system of claim 11, wherein the user reward account is accessible via the web application and the mobile device.

13. The system of claim 11, wherein the software application further causes the mobile device to:
receive and store registration information for a game and edits to the game details.

14. The system of claim 11, wherein the software application further causes the mobile device to:
receive and store registration information for a sponsor and edits to the sponsor details.

15. The system of claim 11, wherein the software application further causes the mobile device to:
receive and store registration information for a developer and edits to the developer details.

16. The system of claim 11, wherein the software application further causes the mobile device to:
receive and store registration information for a user and edits to the user details.

17. The system of claim 11, wherein the reward certificate includes at least one of a bar code, a time stamp, a promotion code, a store location, sponsor URL, and a sponsor logo.

18. The system of claim 11, wherein the software application further causes the mobile device to receive a category designation associated with a user reward account and distributing rewards to the user reward account according to the category designation.

19. The system of claim 18, wherein the category designation is at least one of apparel, cosmetics, sporting goods, geographic location, gender, and age group.

20. The system of claim 11, wherein the selection criteria is at least one of individual user statistics, top reward sponsors, top reward winners, top reward redeemers, sponsored rewards, geographic location, top game players, game popularity, and historical reward information.
